(19) United States
(12) Patent Application Publication
(10) Pub. No.: US 2008/0150693 A1
(43) Pub. Date: Jun. 26, 2008

(54) MULTIPLE LOOP ANTENNA FOR RFID READER, RFID READER HAVING SAME AND RFID SYSTEM HAVING THE RFID READER

(76) Inventors: Hong Jun YOU, Seoul (KR); Woon Geun YANG, Bucheon (KR); Ki-Suk YOON, Incheon (KR); Hyuck Jin KIM, Incheon (KR)

Correspondence Address: OSTROLENK FABER GERB & SOFFEN, 1180 AVENUE OF THE AMERICAS, NEW YORK, NY, 100368403, US

(21) Appl. No.: 11/770,350

(22) Filed: Jun. 28, 2007

(30) Foreign Application Priority Data
Dec. 20, 2006 (KR) 10-2006-0130804

(51) Int. Cl. H04B 7/00; H01Q 21/00

(52) U.S. Cl. 340/10.1; 343/867

(57) ABSTRACT

Disclosed is a multiple loop antenna for a radio frequency identification (RFID) reader, and more particularly, to a multiple loop antenna for a RFID reader that reads information stored in a RFID tag or inputs new information to the RFID tag by inductive coupling.

The multiple loop antenna for a RFID reader serves to communicate information with the RFID tag by inductive coupling, and includes at least three winding groups where they have at least one turn for each group. The winding groups are connected to one another in series and in parallel.

And the same structure is also applicable to RFID tag antenna.

### BACKGROUND OF THE INVENTION

1. Field of the Invention

The present invention relates to a multiple loop antenna for an RFID reader and an RFID Tag, and more particularly, to a multiple loop antenna for an RFID reader that reads information stored in an RFID tag or inputs new information to the RFID tag by an electromagnetic coupling and an RFID Tag.

2. Description of the Related Art

A RFID tag is composed of an IC chip having a memory therein and an antenna, and is installed at a portable product. Information stored in a memory of the RFID tag may be read, or new information may be inputted to the RFID tag through electromagnetic coupling with using an RFID reader.

When a user accesses a non-contact portable product having a RFID tag around a front surface of the RFID reader within a certain distance, the RFID reader may communicate information with the RFID tag without contact between the RFID reader and the RFID tag (hereinafter, RF communication) by electromagnetic coupling between the non-contact portable product and the RFID reader.

The non-contact portable product having a RFID tag such as an IC card, a mobile phone having a wireless payment function, and a wireless identification device communicates information through electromagnetic coupling with a RFID reader.

Instead of a bar code, a product (hereinafter, a non-contact product) is provided with a RFID tag having an antenna and an information storage memory therein. The non-contact product communicates information through electromagnetic coupling with a RFID reader.

The RFID reader should be provided with an antenna therein or in the outside so as to communicate information with the non-contact portable product or the non-contact product. A signal of 13.56 MHz is applied to products such as an IC card corresponding to ISO 14443 or ISO 15693, so an entire circuit has to be resonated near that frequency.

However, as one of several problems in identifying the non-contact portable product, reading distance is a matter of importance. The RFID reader can not read the portable product when the portable product is positioned beyond a certain distance. When the non-contact portable product is positioned beyond a certain distance, a magnetic field weaker than the required for right recognition is formed at there by the RFID reader.

FIG. 1 is a conceptual view showing a series-fed multiple loop antenna for a RFID reader in accordance with the conventional art. And FIG. 2 is a conceptual view showing a parallel-fed multiple loop antenna for a RFID reader in accordance with the conventional art.

As shown in FIG. 1, in the conventional series-fed multiple loop antenna, multiple winding groups are fed in series. A plurality of winding groups 10 and 20 are connected to each other in series.

The conventional loop antenna having a single winding group used in a RFID reader can not identify an object due to a weak magnetic field when it is located in beyond a certain distance from the RFID reader. Also, since magnetic field at the center of a winding is weak, the conventional loop antenna has a low stability when the diameter of the loop antenna has large value. In that case, the conventional series-fed multiple loop antenna could be solution for that.

According to the series-fed multiple loop antenna, winding groups 10 and 20 are connected to each other in series, and a total equivalent inductance is larger than an inductance of each winding group. And total equivalent resistance is larger than a resistance each winding group. So, when the same voltage is applied to the series-fed multiple loop antenna, the current is weak due to large total equivalent impedance.

As shown in FIG. 2, the conventional antenna for a RFID reader has another structure in which multiple winding groups 10 and 20 are connected to each other in parallel. That is, a plurality of winding groups 10 and 20 are installed, and are connected to each other in parallel and in same direction of winding.

The inner winding loop 20 and the external winding loop 10 are wound in the same direction so as to obtain a longer recognition distance by strengthening electromagnetic field at the central position perpendicular to antenna surface. The parallel-fed multiple loop antenna may have a lower total equivalent inductance than an inductance of each winding group. To obtain a typically required inductance value, the number of turns can be increased. Since the external winding group 10 and the inner winding group 20 are connected to each other in parallel, interference between a portable product and the RFID reader may be decreased when the portable product accesses to the RFID reader when the size of reader antenna is larger than the size of the portable product.

However, the conventional parallel-fed multiple loop antenna structure has to be improved for better performances in recognizable distance and design flexibilities so as to recognize the portable product that is positioned relatively far away.

### SUMMARY OF THE INVENTION

Therefore, an object of the present invention is to provide a multiple loop antenna for a RFID reader capable of increasing a recognizable distance by forming larger magnetic field at a center thereof, a RFID tag, a RFID reader having the same, and a RFID system having the RFID reader.

Another object of the present invention is to provide a multiple loop antenna for a RFID reader having a n improved recognizable distance and design flexibilities, a RFID reader having the same, and a RFID system having the RFID reader.

To achieve these and other advantages and in accordance with the purpose of the present invention, as embodied and broadly described herein, there is provided a multiple loop antenna for a RFID reader capable of communicating information with a RFID tag by inductive coupling, the multiple loop antenna including at least three winding groups having at least one turn, wherein the winding groups are connected to each other in series and in parallel.

The winding groups may be wound in the same direction to ensure the same direction for current flow of each winding, and may be installed with an interval therebetween.

The RFID tag may form a part of a product, and the product may be implemented as a portable product.

In addition, there is provided with the RFID reader including the multiple loop antenna in accordance with the present invention, and the RFID system having the RFID reader and the RFID tag.

In addition, there is provided with the multiple loop antenna for a RFID reader in accordance with the present invention capable of communicating information with a RFID tag by inductive coupling, the antenna comprising: at least one series winding group having one end connected to a first power input terminal; and a plurality of parallel winding groups having one end connected to the other end of the series winding group and the other end connected to a second power input terminal.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in, constitute a part of this specification, illustrate embodiments of the invention. And the accompanying drawings together with the description serve to explain the principles of the invention.

In the drawings:

FIG. 1 is a conceptual view showing a series-fed multiple loop antenna for a RFID reader in accordance with the conventional art;

FIG. 2 is a conceptual view showing a parallel-fed multiple loop antenna for a RFID reader in accordance with the conventional art;

FIG. 3 is a conceptual view showing a multiple loop antenna for a RFID reader according to the present invention;

FIG. 4 is a circuit diagram showing a parallel resonance circuit; and

FIG. 5 shows conventional card size averaged strength of magnetic field component (field component which is perpendicular to an antenna surface) according to the distance from the center of the loop antenna on the loop antenna surface when the same driving voltage is applied to the loop antennas for a RFID reader. FIG. 5A shows strength of magnetic field component of the conventional series-fed multiple loop antenna for a RFID reader in FIG. 1; FIG. 5B shows strength of magnetic field component of the conventional parallel-fed multiple loop antenna for a RFID reader in FIG. 2; and FIG. 5C shows strength of magnetic field component of the present invention in FIG. 3.

### DETAILED DESCRIPTION OF THE INVENTION

Reference will now be made in detail to the preferred embodiments of the present invention, examples of which are illustrated in the accompanying drawings.

Hereinafter, a multiple loop antenna for a RFID reader, a RFID reader having the same, and a RFID system having the RFID reader according to the present invention will be explained.

The RFID system comprises a RFID tag (not shown) including an IC chip (not shown) having a memory (not shown) and an antenna (not shown), and a RFID reader for non-contact communication with the antenna of the RFID tag by inductive coupling when the RFID tag accesses within a certain distance.

The RFID tag includes an IC chip having a memory for storing information, and an antenna for supplying power to the IC chip by electromagnetic coupling with the antenna of the RFID reader and is capable of performing information communication.

The RFID tag may be installed at a traffic card, a credit card, a device, a component, etc., or may constitute a part of them.

The RFID reader includes an antenna for communicating information with the RFID tag by inductive coupling, and a main body for reading information stored in the RFID tag or for writing information to the RFID tag.

Hereinafter, the antenna of the RFID reader will be explained in more detail.

The multiple loop antenna for a RFID reader includes at least three winding groups having at least one turns. The winding groups are connected to each other in series and in parallel.

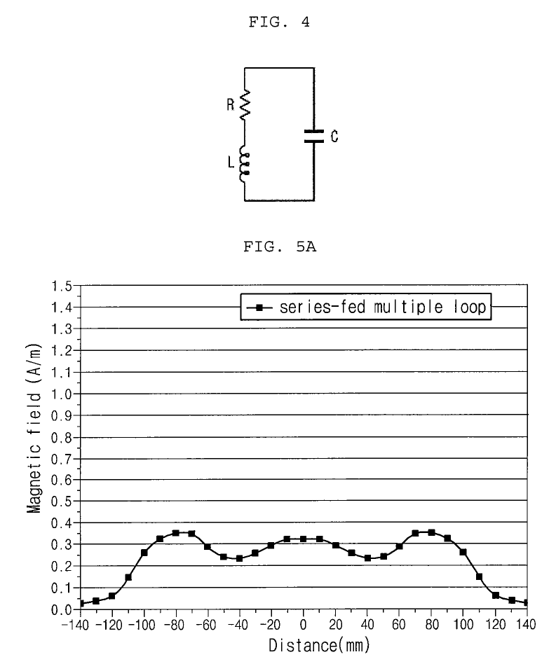

As shown in FIG. 3, the multiple loop antenna for a RFID reader includes: at least one series winding group 100 having one end connected to a first power input terminal 410; and a plurality of parallel winding groups 210, 220 . . . having one end connected to the other end of the series winding group 100 and the other end connected to a second power input terminal 420.

The series winding group 100, the parallel winding group 210, 220 . . . may be formed to have various shapes such as a circular shape or a rectangular shape according to a design, and may be patterned on a substrate.

Hereinafter, the multiple loop antenna for the RFID reader will be explained in more detail.

### EXAMPLES

The number of winding groups in the multiple loop antenna for a RFID reader may be more than or equal to at least N (the N denotes an integer 3). In the preferred embodiment, three winding groups 100, 210, and 220 may be connected to each other in series and in parallel on the basis of the first power input terminal 410 and the second power input terminal 420 for applying a voltage of Vₒ.

The winding groups 100, 210, and 220 may be wound at least one time. The series winding group 100 is wound one time, the first parallel winding group 210 is wound three times, and the second parallel group 220 is wound two times. However, the number of the windings (turns) may be changed according to a usage for the loop antenna.

The winding groups 100, 210, and 220 are wound in a circular shape. However, various shapes such as a rectangular shape and an oval shape may be used.

When two ideal inductors of inductances L₁ and L₂ are connected to each other in series, an equivalent inductance Lₛₜ is obtained by the sum of L₁ and L₂ (Lₛₜ=L₁+L₂). When the two inductors are connected to each other in parallel, the equivalent inductance Lₚₜ is obtained as follows. 1/Lₚₜ=1/L₁+1/L₂, that is, Lₚₜ=(L₁×L₂)/(L₁+L₂). The Lₚₜ has a value less than each of the inductances L₁ and L₂.

When the winding groups are connected to each other in series and in parallel, they have an inductance similar to an inductance when the inductors are connected to each other in series or in parallel.

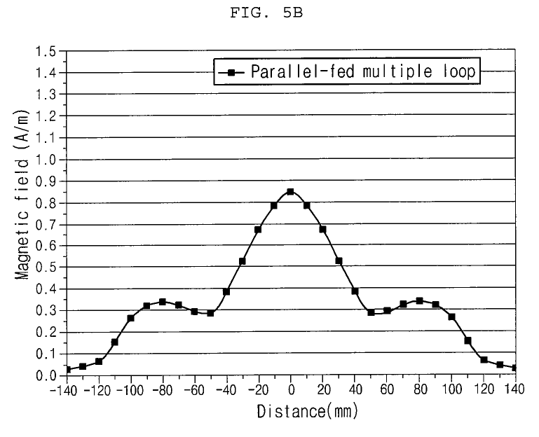

Winding groups can be modeled as resonance circuit of FIG. 4 When the quality factor Q is increased, a usage bandwidth is narrowed. Accordingly, the Q should be in a suitable range of value. Winding groups are connected to each other in series and in parallel so that the total equivalent impedance can be in suitable range of value and the Q value can be controlled to be in a required range.

The inductance is increased as the number of windings is increased and the length of the winding is increased. In case of a series feeding, a total equivalent inductance can not be equal to or less than each inductance of the winding groups. On the contrary, in case of a parallel feeding, a total equivalent inductance can be made to be smaller than each inductance of the winding groups. In the series & parallel-fed multiple loop, we can have flexibility to get a required value of impedance.

In case of the series feeding, the winding groups are connected to each other in series, and thus the same current is applied to the each winding group. In case of the parallel feeding, each current applied to the winding groups can be controlled individually. The series & parallel fed multiple loop can be designed variously. A magnetic field strength around the wire is proportional to the current flow of the wire. In case of the series & parallel fed multiple loop antenna, two current flows for each parallel winding group are added and flow through the serially connected winding group which results strong magnetic field strength.

As shown in FIG. 3, the inner series winding group 100, the first parallel winding group 210, and the external second parallel winding group 220 are wound in the same direction. A magnetic field generated from the first parallel winding group 210 serially connected to the series winding group 100 has to be mixed with a magnetic field generated from the second parallel winding group 220. A radius (r1) of the second parallel winding group 220 can be made not to be smaller than a radius (r2) of the series winding group 100, and a recognition range improvement of the RFID reader can be obtained.

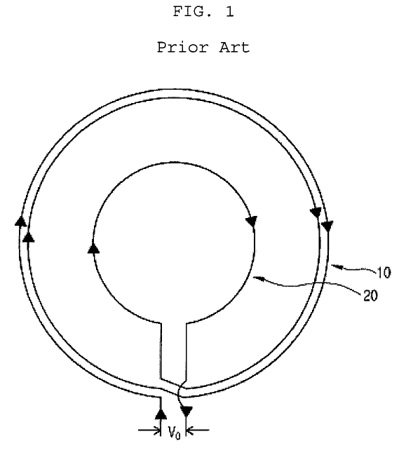

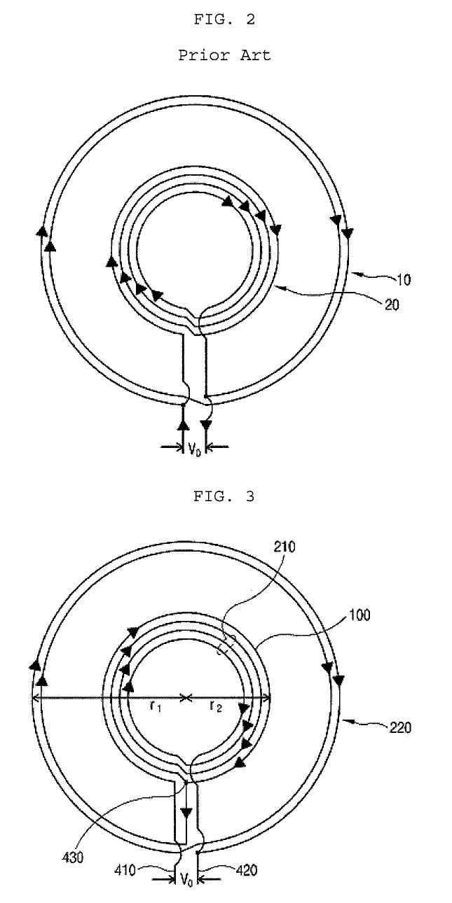

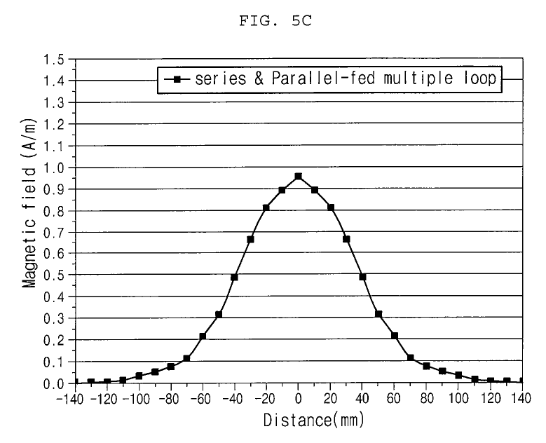

FIG. 5 shows conventional card size averaged strength of magnetic field component (field component which is perpendicular to an antenna surface) according to the distance from the center of the loop antenna on the loop antenna surface when the same driving voltage is applied to the loop antennas for a RFID reader. FIG. 5A shows strength of magnetic field component of the conventional series-fed multiple loop antenna for a RFID reader in FIG. 1; FIG. 5B shows strength of magnetic field component of the conventional parallel-fed multiple loop antenna for a RFID reader in FIG. 2; and FIG. 5C shows strength of magnetic field component of the present invention in FIG. 3.

Meanwhile, the aforementioned antenna structure for a RFID reader may be applied to the antenna structure for a RFID tag.

As aforementioned, the present invention discloses an antenna structure for a RFID reader capable of implementing a longer recognition distance by providing strong magnetic field at the central part of the loop antenna, capable of providing a design flexibilities, capable of communicating a user's non-contact portable product, and capable of stably communicating information according to a resonance characteristic as the portable product comes closer to the antenna.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A multiple loop antenna for a radio frequency identification (RFID) reader that communicates information through an inductive coupling with a RFID tag, comprising:
at least three winding groups of at least one turn for each group,
wherein the winding groups are connected to each other in series and in parallel.

2. The antenna of claim 1, wherein the winding groups are wound in the same direction.

3. The antenna of claim 1, wherein the RFID tag forms a part of a product.

4. The antenna of claim 3, wherein the product is implemented as a portable product.

5. The antenna of claim 1, wherein the winding groups are installed with an interval therebetween.

6. A RFID reader having an antenna having a multiple loop antenna for a radio frequency identification (RFID) reader that communicates information with an RFID tag through an inductive coupling, the multiple loop antenna comprising:
at least three winding groups of at least one turn for each group,
wherein the winding groups are connected to each other in series and in parallel.

7. A RFID system having a RFID reader, having an antenna, having a multiple loop antenna for a radio frequency identification (RFID) reader that communicates information with a RFID tag through inductive coupling, and a RFID tag, the multiple loop antenna comprising:
at least three winding groups of at least one turn for each group,
wherein the winding groups are connected to each other in series and in parallel

8. A multiple loop antenna for a RFID reader capable of communicating information with a RFID tag by inductive coupling, the antenna comprising:
at least one series winding group having one end connected to a first power input terminal; and
a plurality of parallel winding groups having one end connected to another end of the series winding group and another end connected to a second power input terminal.

9. A multiple loop antenna for a radio frequency identification (RFID) tag that communicates information through an inductive coupling with a RFID reader, comprising:
at least three winding groups of at least one turn for each group,
wherein the winding groups are connected to each other in series and in parallel.

10. The antenna of claim 9, wherein the winding groups are wound in the same direction.

11. The antenna of claim 9, wherein the RFID tag forms a part of a product.

12. The antenna of claim 11, wherein the product is implemented as a portable product.

13. The antenna o f claim 9, wherein the winding groups are installed with an interval therebetween.
